(19) United States
(12) Patent Application Publication
(10) Pub. No.: US 2011/0196690 A1
(43) Pub. Date: Aug. 11, 2011

(54) METHOD AND SYSTEM OF SELECTING LANDING PAGES AND OPTIMIZING ROUTING EFFICIENCY

(75) Inventors: Tsafrir PELES, Tel-Aviv (IL); Gilad HELLERMAN, Tel-Aviv (IL); Daniel Reuven SCALOSUB, RaAnana (IL)

(73) Assignee: DSNR Media Group Ltd., RaAnana (IL)

(21) Appl. No.: 12/703,259

(22) Filed: Feb. 10, 2010

(51) Int. Cl. G06Q 10/00; G06Q 30/00; G06F 17/30; G06F 7/10

(52) U.S. Cl. 705/1.1; 707/758; 707/E17.014

(57) ABSTRACT

According to some embodiments of the present invention there is provided a method of selecting a landing page in response to a promotional content request. The method includes receiving a request for a promotional content, having a plurality of landing pages, from a client terminal of a user, obtaining impression data of the request, and providing a plurality of routing efficiency parameters of a routing scenario in each one or more of the landing pages is routed to in response to an impression scenario selected from a plurality of possible impression scenarios. This allows using the dataset to compare the impression data with the plurality of possible impression scenarios to select one of the landing pages, according to the routing efficiency parameters and to route the user to the selected landing page in response to the request.

### FIELD AND BACKGROUND OF THE INVENTION

The present invention, in some embodiments thereof, relates to method and system for routing network users and, more particularly, but not exclusively, to method and system for selecting landing pages and optimizing routing efficiency.

In online marketing a landing page, sometimes known as a lead capture page, appears when a potential customer clicks on an advertisement or a search-engine result link or otherwise impressions promotional content. The landing page usually display content that is a logical extension of the advertisement or link or promotional content, and that is optimized to feature specific keywords or phrases for indexing by search engines.

Common methods of experimentation-based landing page optimization are A/B testing, or A/B split testing, which is a method for testing two versions of a webpage, Multivariate landing page optimization (MVLPO), where multiple variations of visual elements (e.g., graphics, text) on a webpage are evaluated, and total-experience testing in which the entire website experience of the visitor is examined using technical capabilities of the website platform. These methodologies are applicable to both closed- and open-ended experimentation.

During the last years various mechanisms for optimizing the selected landing pages have been developed. U.S. Pat. No. 6,662,215 describes a communication method for communication between a user computing device and a first server arrangement includes the steps of: transmitting a communication, which includes data representing a characteristic of the user computing device, from the first server arrangement to a second server arrangement; selecting a population segment in accordance with the user characteristic; determining a content in accordance with the user characteristic; transmitting a first response, which includes data representing the determined content, from the second server arrangement to the first server arrangement; and transmitting a second response, which includes at least the determined content, from the first server arrangement to the user computing device. The content corresponds to a plurality of concept elements.

Another example is described in U.S. Patent Application Publication No. US 2008/0243797, filed on Mar. 28, 2008 describes method and system for displaying a keyword advertisement through retrieval of an optimal landing page associated with a detailed keyword, and displaying the retrieved landing page for a user, instead of displaying a non-specific landing page associated with the advertisement keyword included in the detailed keyword. A method of displaying a keyword advertisement includes: receiving from a user a detailed keyword that includes one or more advertisement keywords purchased by an advertiser and character strings; dynamically retrieving a landing page according to the received detailed keyword; and displaying page information of the landing page for the user.

### SUMMARY OF THE INVENTION

According to some embodiments of the present invention there is provided a method of selecting a landing page in response to a promotional content request. The method comprises obtaining impression data of a request for a promotional content from a user, the promotional content having a plurality of landing pages, providing a plurality of routing efficiency parameters of a plurality of routing scenarios, in each the routing scenario one of the landing page being routed to in response to one of a plurality of possible impression scenarios, selecting one of the plurality of landing pages using the plurality of routing efficiency parameters and by comparing the impression data with the plurality of possible impression scenarios, and routing the user to the selected landing page in response to the request.

Optionally, the impression data comprises pre impression data.

Optionally, the method further comprises computing the routing map according to an analysis of a plurality of user actions taken in response to routing a plurality of users to the plurality of landing pages according to impression data of a plurality of requests submitted by them.

More optionally, the analysis is a statistical analysis.

Optionally, the obtaining comprises obtaining impression data of a combination of at least two members of a group consisting of: a webpage address, a uniform resource locator (URL) string, banner identification, an IP address, an origin of a respective promotional content impression, a query comprising a keyword directing a user to an origin webpage.

Optionally, the method further comprises calculating the plurality of routing efficiency parameters according to a return of investment (ROI) data of each the user action.

More optionally, the calculating comprises acquiring the ROI data from a customer relationship management (CRM) system.

Optionally, the plurality of landing pages comprise a plurality of different conversion paths.

Optionally, the plurality of landing pages comprises a plurality of different microsites.

Optionally, the providing comprises providing a user profile of the user, the user profile being created according to at least one characteristic of a desired action performed by the user.

Optionally, the plurality of routing efficiency parameters are plurality of conversion rates.

According to some embodiments of the present invention there is provided a method of creating a dynamic routing map. The method comprises providing a plurality of landing pages for a promotional content, storing a dataset comprising a plurality of routing efficiency parameters of a plurality of routing scenarios in each the routing scenario at least one of the landing page being routed to in response to an impression scenario from a plurality of possible impression scenarios, receiving a plurality of requests for the promotional content, for each the request: identifying a match between impression data of the request and impression scenario from a plurality of possible impression scenarios, routing a respective requesting user with a first of the plurality of landing pages, and identifying a user action taken in response to the routing. In addition the method comprises updating at least one respective the routing efficiency parameter according to the user action and providing the updated dataset to route a plurality of additional requests to the plurality of landing pages.

Optionally, the updating comprises updating the dataset without storing any identifying data about the user.

Optionally, the identifying comprises identifying a return on investment (ROI) of the user action; further comprising computing ROI of a respective the routing scenario according to the ROI.

Optionally, the receiving comprises normalizing each the request.

According to some embodiments of the present invention there is provided a 1 system of selecting a landing page from a plurality of landing pages in response to a promotional content request. The system comprises a network interface which receives a request for a promotional content from a client terminal of a user, a database which hosts a at least one routing efficiency parameter of each of a plurality of routing scenarios, at least one of the landing page being routed to in response to one of a plurality of possible impression scenarios in each the routing scenario, and a routing engine which obtains impression data of the request and selects one of the plurality of landing pages according to a comparison between the impression data and the plurality of possible impression scenarios and to the at least one routing efficiency parameter, the routing engine routes the user to the selected landing page in response to the request.

Optionally, the system further comprises a rule engine which monitors a plurality of actions performed in response to routing a plurality of users to the plurality of landing pages and updates the at least one routing efficiency parameter accordingly.

Optionally, the system further comprises a return on investment (ROI) module which estimates a ROI of each the routing scenario, the routing engine perform the selection according to the ROI.

Optionally, the database hosts a plurality of user profiles each documenting a plurality of desired actions performed in response to the presentation of at least some of the plurality of landing pages in response to a plurality of requests with various impression data, the plurality of requests being submitted by a unique user.

According to some embodiments of the present invention, there is provided an advertisement platform that comprises the aforementioned system.

According to some embodiments of the present invention there is provided a method of selecting a landing page in response of a request of promotional content. The method comprises obtaining an impression data of a request for a promotional content, testing a compliance of the impression data with a plurality of dynamic rules, the plurality of dynamic rules being set according to a plurality of routing efficiency parameters of a plurality of landing pages routed to in response to a plurality of requests having a plurality of possible impression scenarios, selecting a certain landing page of the plurality of landing pages according to the testing, and providing the certain landing in response to the request.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volitile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system of selecting landing pages according to an analysis, optionally statistical, of impression data and responsiveness to various landing pages, according to some embodiments of the present invention;

FIG. 2 is a schematic illustration of the system of FIG. 1 with a return of investment module, according to some embodiments of the present invention;

FIG. 3 is a method of selecting land pages according to statistical analysis of impression data and responsiveness to various landing pages, according to some embodiments of the present invention;

FIG. 4 is an exemplary schematic illustration of a block chart that depicts user actions performed during a landing page selection process, according to some embodiments of the present invention; and

FIG. 5 is a schematic illustration of an advertisement platform including the system of FIG. 1, according to some embodiments of the present invention.

### DESCRIPTION OF EMBODIMENTS OF THE INVENTION

The present invention, in some embodiments thereof, relates to method and system for routing network users and, more particularly, but not exclusively, to method and system for selecting landing pages and optimizing routing efficiency.

According to some embodiments of the present invention there is provided a system and method of selecting a landing page in response to an analysis of the impression data user data and/or post-conversion data, for brevity referred to herein as impression data, of a request for promotional content of a campaign. The analysis is based on a dataset that maps routing efficiency parameters, such as conversion rates and return of investment, of different routing scenarios. Each routing scenario defines a landing page which is routed to in response to an impression scenario selected from a plurality of possible impression scenarios. According to some embodiments of the present invention there is also provided a system and method of creating a set of rules for selecting landing pages according to a statistical analysis of user actions which are taken in response to different routing scenarios.

According to some embodiments of the present invention there is provided a method of selecting a landing page in response of a request for promotional content of a campaign. The landing page is selected from a plurality of landing pages which are related to the product campaign, for example various webpages with different characteristics, such as different color, font, textual promotional content, visual promotional content, and the like. The method is based on obtaining impression data of the request, for example pre click data, such as a directing web site, a clicked banner, a characteristic of the directing web site and/or the clicked banner, user data, such as estimated origin country and operating system and/or routing navigator of the used client terminal and click information, and testing the compliance thereof with a plurality of dynamic rules. The dynamic rules are optionally created and/or adjusted according to analysis, optionally statistical, of user actions which are induced by various routing scenarios. The dynamic rules may be based on routing efficiency parameters, such as the conversion rates, of the plurality of landing pages which are routed to in response to requests having different impression data. The testing allows selecting one of the plurality of landing pages and routing, for example redirecting the user who submitted the request, to the selected landing page.

According to some embodiments of the present invention there is provided a system of selecting a landing page in response to a request for a promotional content of a campaign. The system includes a network interface that receives a request for the promotional content from a client terminal of a user. The system further includes one or more databases which host a dataset, referred to herein as a routing map, that maps routing scenarios and their routing efficiency parameters, such as their conversion rates. The system further includes a routing engine which obtains impression data of the received request and selects accordingly, using the routing map, one of the landing pages. The routing engine routes the user to the selected landing page in response to the received request.

Optionally, the system further includes a rule engine that monitors a plurality of actions which are performed in response to the routing of users to the landing pages in response to different requests with different impression data and updates the dataset accordingly.

Optionally, the system further includes a return of investment (ROI) module which estimates a ROI of some or all of the mapped routing scenarios. In such a manner, the routing may be performed to increase the ROI regardless the conversion rate. In such an embodiment, a user who performed a desired action with high profitability increases the ROI of the routing scenario he followed more than another user who performed a desired action with low or no profitability. In such a manner, routing scenarios with higher ROI may receive higher priority than routing scenarios with lower ROI even if their conversion rate is higher. Such an embodiment may require a connection to a customer relationship management (CRM) system, as further described below.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

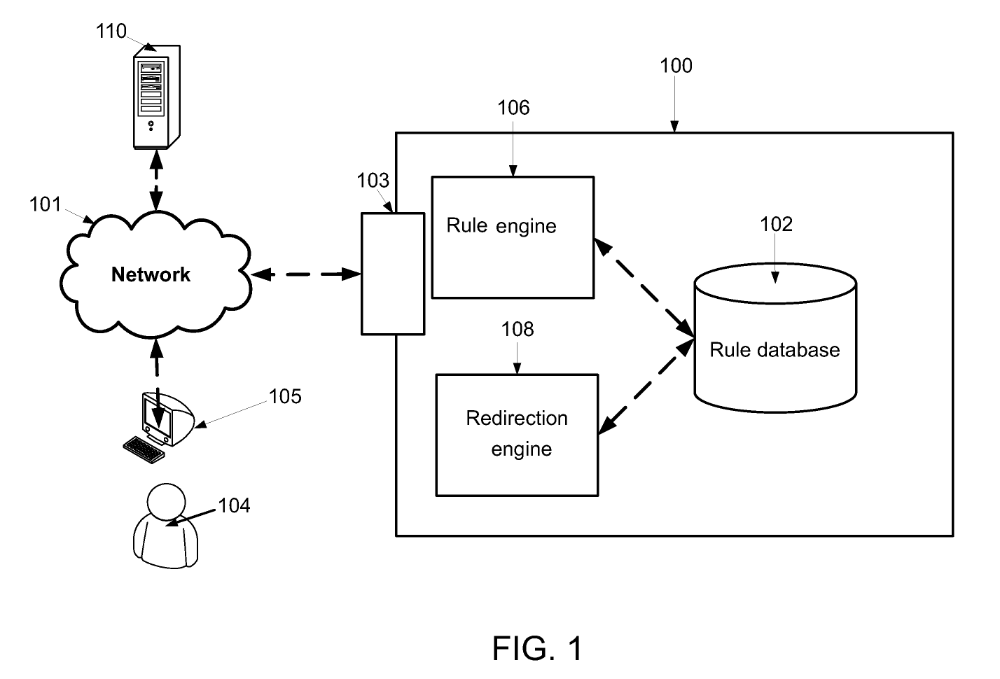

Reference is now made to FIG. 1, which is a schematic illustration of a system 100 of selecting a landing page in response to a promotional content request, according to some embodiments of the present invention. As used herein, a landing page means a single landing page, a microsite, and/or a conversion path.

The system 100, which is optionally implemented on one or more network servers, is connected to a network 101, such as the Internet. The system includes a network interface 103, such as a physical network port, for example a network interface card (NIC) that functions as an input module. The network interface 103 receives a promotional content request for a certain promotional content of a campaign from a network user 104. The promotional content request, which may be referred ti herein as a request, may be in the form of a click on a banner, an impression event, a submission of a search query, an impression for a search-engine result, a pass through event of a pointer, and the like. The promotional content request may be received directly from a client terminal 105 of the user 104 and/or from a server managing a certain hosting site accessed by the user 104. As used herein, and for brevity, an hosting site means a network accessible content, such as a webpage, a video file having active links and/or banners, an audio file having active links and/or banners, a podcast having active links and/or banners, a WORD document, a portable document format (PDF), a spreadsheet, an extensible markup language (XML) page, a hypertext markup language (HTML) page, and/or any other network accessible content file.

The system 100 further includes a routing engine 108, which may be a redirection engine. The routing engine 108 extracts impression data from the promotional content request. The impression data may includes pre impression data, such as pre click data, impression data, such as hosting site address and banner identification, and/or post impression data, such as landing page activity, from the received promotional content requests and/or for receiving such impression data from an external source, such as the server that hosts the hosting sites. The pre impression data may be gathered using various methods. For example pre-click information may be based on the HTTP header of the request and/or related data received from the advertisement server that provides the request to the system, for example via a URL query string.

Optionally, the pre impression data includes web navigation details such as an address of the hosting site, an origin webpage in the hosting site, a banner identification, an internet protocol (IP) address, a query comprising one or more keywords which have been submitted in the hosting site, query comprising one or more keywords which have directed the user to the hosting site, and the like.

As further describes below, the routing engine 108 uses the impression data to select a landing page using the system's rule database, as shown at 102. The rule database 102 having routing rules, for example redirection rules, optionally dynamic, for selecting landing pages for each one of promotional content of a plurality of campaigns. For clarity, a certain campaign may be for promoting a product, a service, a website, a show, a movie, and the like. The landing pages may be hosted in the system 100 and/or in a third party server, such as shown at 110.

Each one of the campaigns is associated with a plurality of landing pages, for example 2, 3, 5, 10, 20, 50, and or any intermediate or larger number. Optionally, for each one of the campaigns, the routing rules define which possible impression scenarios should invoke the loading of which landing pages.

Each possible impression scenario is a combination of two or more web navigation details. For example, an impression scenario may include a user that clicks on a banner having a certain banner identification from an hosting site having a certain uniform resource locator (URL) string, a user that submits a query having a certain set of keywords from a certain hosting site, a user from a certain geographic origin that clicks on a first banner from a certain origin webpage and not on other banners from that certain origin webpage, and/or the like.

The routing engine 108 selects a landing page according to the compliance of the impression data with the routing rules. Optionally, the routing rules are based on a comparison between the impression data of the promotional content request and the possible impression scenarios in the rule database 102. The compliance may be checked by data-mining methods. The data mining algorithms may be as defined in Data Mining Practical Machine Learning Tools and Techniques, Second Edition (Morgan Kaufmann Series in Data Management Systems) by Ian H. Witten and Eibe Frank, 2005, which is incorporated herein by reference. The data mining is used to search large volumes of data pertaining to promotional content requests and landing pages induced user action to find patterns or behavior, using techniques from machine learning, pattern recognition and statistics. For example, the routing engine 108 selects a landing page based on the frequency of promotional content requests with such impression data, summarization, classification, regression, clustering, Bayesian methods and the like. The algorithms may have the ability to self-evolve and self-adapt to changing conditions, and may be supervised or unsupervised.

The system further includes an output module, which may be the network interface 103. The output module provides the one or more selected landing pages and/or links thereto in response to the impression, facilitating the presentation thereof to the user 104.

According to some embodiments of the present invention, the system includes a rule engine 106 that adjusts the routing rules, optionally according to routing efficiency parameters, such as the conversion rates of different landing pages with respect to different impression scenarios. A routing efficiency parameter, such as a conversion rate reflects the rate, proportion, and/or percentage of unique visitors who take a desired user action, such as purchasing or downloading, upon visiting a landing page that is loaded in response to a promotional content request with a impression data that matches to a certain impression scenario. As used herein, a user action means a positive or a negative reaction to a landing page of a promotional content of a campaign, such as purchasing, printing, downloading, renting, leasing, subscribing, visiting and the like. The action may be taken immediately after the landing page is presented and/or after a period, for example when the user visits a store and/or a website. The routing efficiency parameter may be an absolute number or a relative value, for example the relative portion of desired user actions which a certain landing page receives from all the possible landing pages of a certain campaign.

Optionally, these routing efficiency parameters are used for creating and/or updating the routing rules. The user actions taken by the users may be documented in the rule database 102, optionally with a related routing scenario or in association therewith.

For brevity, a routing session is defined herein as a session which starts when a promotional content request is received, with a certain impression data, such as pre click data, and ends with a certain landing page that is presented in response to the request. A routing scenario defines such a routing session.

According to the aforementioned embodiments, the rule engine 106 monitors one or more routing efficiency parameters, such as conversion rates of different routing scenarios.

Optionally, each documented user action is weighted. The weight may decrease over time. In such a manner, the effect of new impressions on the landing page selection process is higher than the effect of older impressions on the landing page selection process.

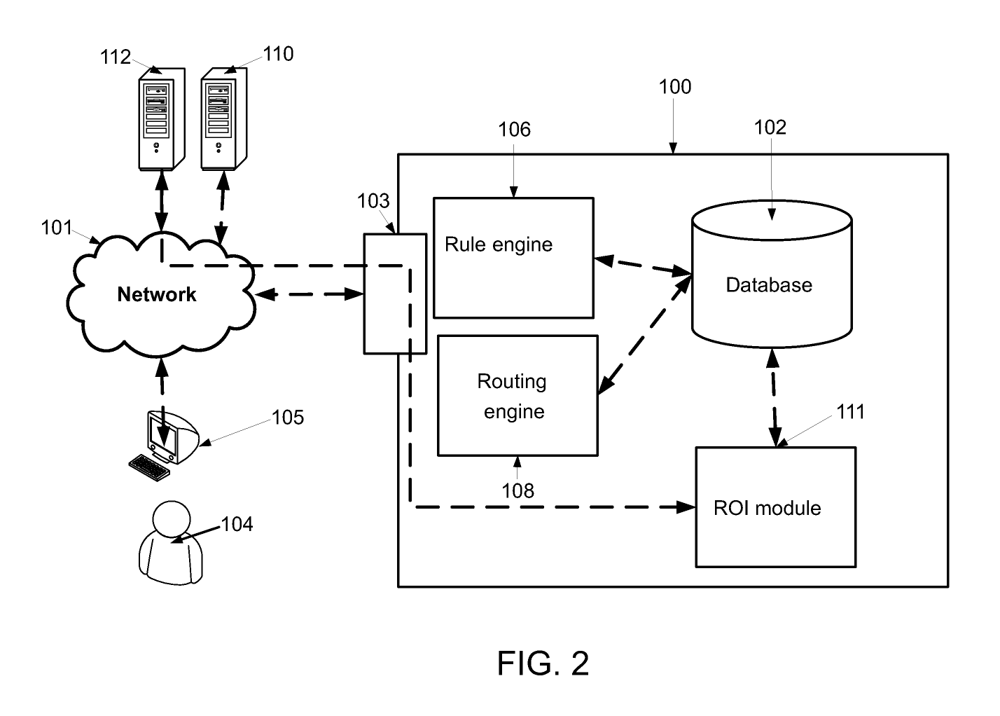

Reference is now made to FIG. 2, which is a schematic illustration of the system 100 of FIG. 1 with a return of investment (ROI) module 111. As described above, desired user actions may be actions which their utility cannot be estimated immediately after the landing page is presented. For example, a desired action such as subscribing to a service, such as an online gambling site, a pay per use service, and/or a pay period service may have various ROI values. In the course of time, the ROI values of this desired action may range from 0 to thousands of U.S dollars or even more. The ROI module 111 is optionally connected to a customer relationship management (CRM) system 112 of the service and/or product provider that is promoted by the respective campaign. In such a manner, the ROI module may receive data about the ROI of each desired action. For example, two users which are subscribed to a gambling service may gamble on different amounts of money and therefore may have different ROI. By identifying the ROI of each desired action, the ROI module may document the ROI of different routing scenarios. In such a manner, the routing rules may be updated and/or automatically calculated according to the ROI of different routing scenarios. For example, each routing scenario may be weighted according its ROI. In another embodiment each routing scenario is scored according to its ROI.

According to some embodiments of the invention, no identifying information about the various network users which submit promotional content requests is stored in the database. In such a manner, no definite statement is made, or can be made, about a particular user involved at process at any time.

According to other embodiments of the present invention, a number of user profiles are stored in the rule database 102. Each user profile documents or otherwise indicates the routing sessions which have been performed by the user. These routing sessions may be identified by various known methods, for example according to the IP address of the users. In such embodiments, statistical analysis techniques may reveal personalized rules which may assist in matching a landing page to a user according to her specific user profile.

In such an embodiment, characteristics of a landing page that induces a desired user action from the user are identified and stored in the user profile. Optionally, the characteristics are weighted according their success in inducing desired user actions of the user. For example, a characteristic that has been identified in three landing pages which induced a desired user action is weighted and ranked higher that a characteristic which has been identified in only one landing page which induced a desired user action and/or in a landing page which has not induced a desired user action at all. In use, these characteristics are matched with characteristics of potential landing pages so as to assist in the landing page selection process.

In use, the rule engine 106 monitors the user actions which are taken by the network users 104 in response to the landing pages which are presented thereto, during different routing sessions. In such a manner, the rule engine 106 may compute and/or update the routing efficiency parameter of each routing session in real time based on actual statistical analysis of user actions taken in different routing sessions. Optionally, the routing sessions and their routing efficiency parameters are documented in the rule database 102.

Optionally, the rule engine 106 runs a periodic check, such as a daily check, to validate and/or update the routing rules. During the periodic check the rule engine 106 determines whether a rule has been constructed properly, for example in light of the routing efficiency parameter, such as the conversion rate, and optionally whether it functions well and requires refinements.

In use, the routing engine 108 selects one or more landing pages in response to a received promotional content request by identifying which of the routing scenarios have a matching impression scenario and the its conversion rate. The selected landing page is used to respond to the received promotional content request.

Optionally, the routing engine 108 selects the landing pages of routing scenarios having a matching impression scenario and the highest routing efficiency parameters, for example the highest conversion rate and/or ROI, which is optionally calculated as described below.

For clarity, it should be noted that in this example, the routing engine 108 selects between two landing pages according to a rule that defines the relation among impression scenarios with two parameters, however the routing engine 108 may select among various landing pages according to rules that define the relation among impression scenarios with multiple parameters. The parameter space on which the selection is performed, for example using a data mining process may involve many parameters which may be affected according to the preferences defined in the user profile of the related user.

It should be noted that in such embodiments landing pages are selected based on empirical analysis, such as the conversion rate of routing scenarios with certain routing scenario, and not on psychological interpretations and/or assumptions about the network user behavior. Moreover, as the routing rules may be instantly updated according to network users' user actions, the redirection of users is based on up-to-date surfing patterns and behaviors which tend to change over time.

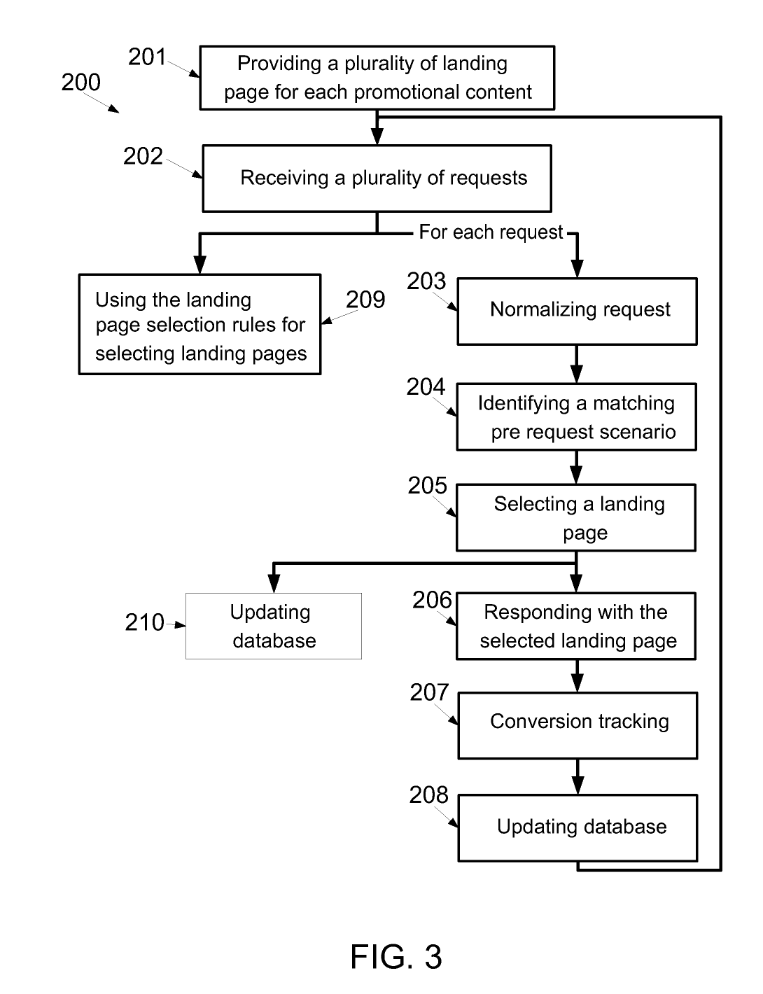

Reference is now made to FIG. 3, which is a flowchart of a method 200 of a learning process in which dynamic routing rules are created and/or updated according to a statistical analysis of user actions taken by a plurality of network users in response to routing sessions with various routing scenarios, according to some embodiments of the present invention. The method depicted in FIG. 3 may be used for creating a dataset, which is stored in the rule database 102 and facilitates the selection of landing pages as described below.

The method 200 depicts a series of user actions and/or steps performed in a non obligatory manner for associating various impression scenarios which are optional for a promotional content request of certain campaign however may be repeated for associating the impression scenarios of various campaigns.

First, as shown at 201, a plurality of landing pages of a promotional content OF a certain campaign, links thereto, and/or any other landing page identifier are provided. The landing pages may be stored on the server of the campaign manager, respective product supplier and/or advertiser. The number of possible landing pages may range between 2 and thousands, or even more. Different landing pages may vary in their font, color, styling, writing style, offers, wording, models, size, terms of purchase, terms of sell, terms of rights, terms of use, availability, time, and/or the like. The landing pages may be generated automatically by a landing page generator and/or manually by a content provider. Optionally, each landing page is marked with a unique ID, such as a unique URL. Optionally, the landing pages, or links thereto, are stored in the rule database 102.

Now, as shown at 202, a plurality of requests for promotional content of a plurality of different campaigns are received. Each received promotional content request is going through a number of processes.

Optionally, as shown at 203, the data about the promotional content request is normalized. The normalization optionally includes cleaning the promotional content request from redundant data, for example by removing noise, and preprocessing it, for example for extracting impression data. The normalization, for example the extraction and the collection of data and the noise reduction may be adjusted according to the promotional content request.

The noise reduction and data extraction may involve finding useful features to represent the data, an operation which may depend on the type of the promotional content request and/or operator's preference. With dimensionality reduction or transformation methods, the effective number of variables under consideration may be reduced, or invariant representations for the data may be found.

Now, as shown at 204, an impression scenario which matches to the extracted impression data is identified. The impression scenario is identified from a plurality of scenarios, which are stored in the rule database 102. Optionally, if the extracted impression data is indicative of an impression scenario which is not documented in the rule database 102, a new respective impression scenario is added to the rule database 102.

Now, as shown at 205, a landing page is selected according to the matched impression scenario. The selection may be performed by the routing engine 108, according to the routing rules, for example as outlined above and described below. Optionally, as shown at 210, the database 102 is updated to document the selection.

As shown at 206, the promotional content request is responded to with the selected landing page. In such a manner, the selected landing page is presented to the user 104, for example on the screen of the client terminal 105.

Now, as shown at 207, an action taken by the user 104, in response to the presentation of the selected landing page, is monitored. Additionally or alternatively, this information is provided by the server that hosts the landing pages and/or the advertiser that provided the campaign.

As shown at 208, this information allows updating the routing rules. For example, when the routing rules map the routing efficiency parameters, such as conversion rates, of routing sessions with different routing scenarios, the information allows updating the routing efficiency parameters of the routing sessions with a routing scenario having a respective impression scenario and a respective landing page.

As shown at 209, the routing rules are used for selecting landing pages. Optionally, the routing rules are used during the learning process and/or for selecting landing pages in response to promotional content requests which are not part of the learning process.

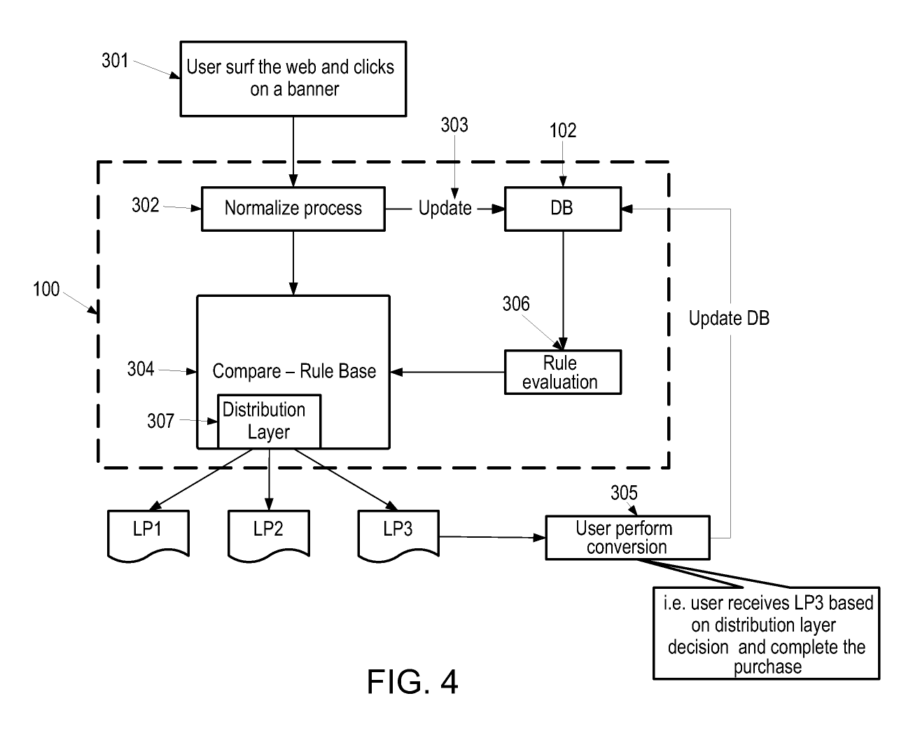

Reference is now also made to FIG. 4, which is an exemplary schematic illustration of a block chart that depicts user actions performed during a landing page selection process, according to some embodiments of the present invention. It should be noted that blocks depicting user actions performed by the system 100 are encircled by a dashed line.

First, as shown at 301, a network user clicks on a banner hosted in a certain hosting site. Then, as shown at 302, the click, along with some pre-click information, is collected and normalized, for example as described above.

Now, as shown at 303, the database that hosts the routing rules is updated, for example according to the learning process depicted in FIG. 3.

In parallel, as shown at 304, a landing page is selected according to the compliance of the click, along with some pre-click information, with the routing rules. For example, the click, along with some pre-click information, is matched with the routing scenario associated with the highest routing efficiency parameters and the landing page depicted by it is selected.

Optionally, the landing pages are distributed via a distribution layer 307, where the portion of traffic that is allocated to each landing page is monitored, optionally statistically, and enforced, for example by adjusting the routing rules.

As shown at 305, the user action performed by the user in response to the presentation of the selected landing page is monitored. The monitoring allows reevaluating the routing rules, for example according to a change in the routing efficiency parameters, as shown at 306.

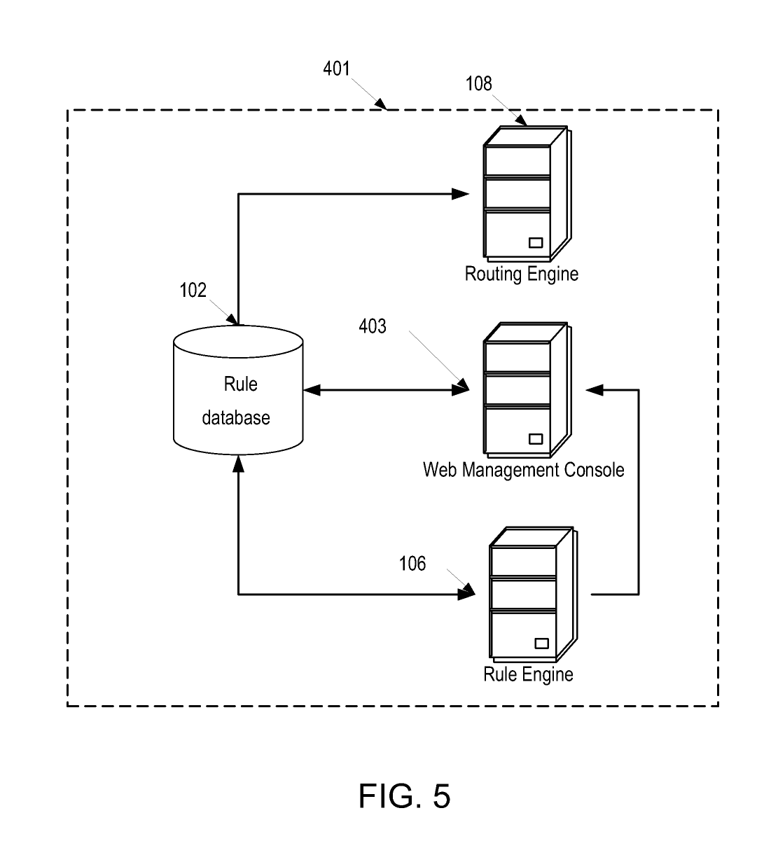

According to some embodiments of the present invention, the system 100 is part of an advertisement platform. Reference is now made to FIG. 5, which is a schematic illustration of an advertisement platform 401, according to some embodiments of the present invention.

The advertisement platform 401 includes the routing engine 108 that receives promotional content requests from network client terminals and redirects the submitting entities to various landing pages according to the routing rules.

The advertisement platform 401 further includes a web management console 403 that allows an advertiser and/or a system operator to create a campaign, view reports about the campaign and/or the routing efficiency parameters, manually adjust and/or create routing rules, optimize the campaigns and the like. Such a web management console may be implemented as known in the art.

The advertisement platform 401 further includes the rule engine 106 that updates and/or creates the routing rules, for example as described above. The automatic rules engine 106 supplies the routing rules to the routing engine 108, for example by applying data mining algorithms on the rule database 102, optionally as described above.

It is expected that during the life of a patent maturing from this application many relevant systems and methods will be developed and the scope of the term promotional content request, campaign, impression, impression data, a server, a client terminal, a hosting site, and a promotional content is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of selecting a landing page in response to a promotional content request, comprising:
obtaining impression data of a request for a promotional content from a user, said promotional content having a plurality of landing pages;
providing a plurality of routing efficiency parameters of a plurality of routing scenarios, in each said routing scenario one of said landing page being routed to in response to one of a plurality of possible impression scenarios;
selecting one of said plurality of landing pages using said plurality of routing efficiency parameters and by comparing said impression data with said plurality of possible impression scenarios; and
routing said user to said selected landing page in response to said request.

2. The method of claim 1, wherein said impression data comprises pre impression data.

3. The method of claim 1, further comprising computing said routing map according to an analysis of a plurality of user actions taken in response to routing a plurality of users to said plurality of landing pages according to impression data of a plurality of requests submitted by them.

4. The method of claim 3, wherein said analysis is a statistical analysis.

5. The method of claim 1, wherein said obtaining comprises obtaining impression data of a combination of at least two members of a group consisting of: a webpage address, a uniform resource locator (URL) string, banner identification, an IP address, an origin of a respective promotional content impression, a query comprising a keyword directing a user to an origin webpage.

6. The method of claim 1, further comprising calculating said plurality of routing efficiency parameters according to a return of investment (ROI) data of each said user action.

7. The method of claim 6, wherein said calculating comprises acquiring said ROI data from a customer relationship management (CRM) system.

8. The method of claim 1, wherein said plurality of landing pages comprise a plurality of different conversion paths.

9. The method of claim 1, wherein said plurality of landing pages comprises a plurality of different microsites.

10. The method of claim 1, wherein said providing comprises providing a user profile of said user, said user profile being created according to at least one characteristic of a desired action performed by said user.

11. The method of claim 1, wherein said plurality of routing efficiency parameters are plurality of conversion rates.

12. A method of creating a dynamic routing map, comprising:
providing a plurality of landing pages for a promotional content;
storing a dataset comprising a plurality of routing efficiency parameters of a plurality of routing scenarios in each said routing scenario at least one of said landing page being routed to in response to an impression scenario from a plurality of possible impression scenarios;
receiving a plurality of requests for said promotional content, for each said request:
identifying a match between impression data of said request and impression scenario from a plurality of possible impression scenarios,
routing a respective requesting user with a first of said plurality of landing pages, and
identifying a user action taken in response to said routing,
updating at least one respective said routing efficiency parameter according to said user action; and
providing said updated dataset to route a plurality of additional requests to said plurality of landing pages.

13. The method of claim 12, wherein said updating comprises updating said dataset without storing any identifying data about said user.

14. The method of claim 12, wherein said identifying comprises identifying a return on investment (ROI) of said user action; further comprising computing ROI of a respective said routing scenario according to said ROI.

15. The method of claim 12, wherein said receiving comprises normalizing each said request.

16. A system of selecting a landing page from a plurality of landing pages in response to a promotional content request, comprising:
a network interface which receives a request for a promotional content from a client terminal of a user;
a database which hosts a at least one routing efficiency parameter of each of a plurality of routing scenarios, at least one of said landing page being routed to in response to one of a plurality of possible impression scenarios in each said routing scenario; and
a routing engine which obtains impression data of said request and selects one of said plurality of landing pages according to a comparison between said impression data and said plurality of possible impression scenarios and to said at least one routing efficiency parameter, said routing engine routes said user to said selected landing page in response to said request.

17. The system of claim 16, further comprising a rule engine which monitors a plurality of actions performed in response to routing a plurality of users to said plurality of landing pages and updates said at least one routing efficiency parameter accordingly.

18. The system of claim 16, further comprising a return on investment (ROI) module which estimates a ROI of each said routing scenario, said routing engine perform said selection according to said ROI.

19. The system of claim 16, wherein said database hosts a plurality of user profiles each documenting a plurality of desired actions performed in response to the presentation of at least some of said plurality of landing pages in response to a plurality of requests with various impression data, said plurality of requests being submitted by a unique user.

20. An advertisement platform comprising the system of claim 16 and a web management console which manages the plurality of landing pages.

21. A method of selecting a landing page in response of a request of promotional content, comprising:
obtaining an impression data of a request for a promotional content;
testing a compliance of said impression data with a plurality of dynamic rules, said plurality of dynamic rules being set according to a plurality of routing efficiency parameters of a plurality of landing pages routed to in response to a plurality of requests having a plurality of possible impression scenarios;
selecting a certain landing page of said plurality of landing pages according to said testing; and
providing said certain landing in response to said request.
